(19) United States
(12) Patent Application Publication
(10) Pub. No.: US 2026/0062011 A1
(43) Pub. Date: Mar. 5, 2026

(54) VEHICLE CONTROL SYSTEM

(71) Applicant: DENSO CORPORATION, Kariya-city (JP)

(72) Inventors: Ataro YAMADA, Kariya-city (JP); Yoshitaka TANEMURA, Kariya-city (JP); Yusuke KANI, Kariya-city (JP); Hideyuki YAMAGUCHI, Kariya-city (JP)

(21) Appl. No.: 19/386,008

(22) Filed: Nov. 11, 2025

Related U.S. Application Data
(63) Continuation of application No. PCT/JP2024/017625, filed on May 13, 2024.

(30) Foreign Application Priority Data
May 15, 2023 (JP) 2023--080017

(51) Int. Cl. B60W 50/00; B60R 16/023

(52) U.S. Cl. CPC B60W 50/0097; B60R 16/0231

(57) ABSTRACT

A vehicle control system includes at least one vehicle control device and an operation control device, and is configured to: in response to a first command being input from an application, determine whether the first command can be accepted based on resource information that is related to a processing capacity of resource to be used by the first command; output, in response to determining that the first command can be accepted, a second command to an operation control program that is installed in the operation control device; in response to determining that the first command cannot be accepted, determine whether the first command can be accepted within a predetermined duration based on the resource information; and wait until the first command can be accepted and output the second command to the operation control program in response to determining that the first command can be accepted within the predetermined duration.

### CROSS REFERENCE TO RELATED APPLICATIONS

The present application is a continuation application of International Patent Application No. PCT/JP2024/017625 filed on May 13, 2024, which designated the U.S. and claims the benefit of priority from Japanese Patent Application No. 2023-080017 filed on May 15, 2023. The entire disclosures of all of the above applications are incorporated herein by reference.

### TECHNICAL FIELD

The present disclosure relates to a technology for processing a request from application software that provides a service using a vehicle function.

### BACKGROUND

Conventionally, a vehicle data collection system collects information only under a situation specified by a server for effectively use the system resource. The data collection system is configured to collect, from multiple vehicles, various vehicle data detected by sensors mounted on the vehicles.

### SUMMARY

According to an aspect of the present disclosure, a vehicle control system, which is mounted on a vehicle, includes at least one vehicle control device and an operation control device. The at least one vehicle control device includes at least one processor with a memory storing computer program code. The at least one processor with the memory may be configured to: in response to a first command being input from an application of the at least one vehicle control device, determine whether the first command can be accepted based on resource information, the resource information being related to a processing capacity of resource to be used by the first command; output, in response to determining that the first command can be accepted, a second command, which is generated based on the first command, to an operation control program that is installed in the operation control device for controlling a control target; in response to determining that the first command cannot be accepted, determine whether the first command can be accepted within a predetermined duration based on the resource information; and wait until the first command can be accepted and then output the second command to the operation control program in response to determining that the first command can be accepted within the predetermined duration.

### BRIEF DESCRIPTION OF DRAWINGS

The present disclosure will become apparent from the following detailed description made with reference to the accompanying drawings. In the drawings:

FIG. 1 is a block diagram showing a configuration of a vehicle control system;

FIG. 2 is a block diagram showing a configuration of an ECU;

FIG. 3 is a block diagram showing a configuration of a center;

FIG. 4 is a block diagram showing a functional configuration of the vehicle control system;

FIG. 5 is an explanatory diagram showing an example of contents of required resource information;

FIG. 6 is a sequence diagram showing a flow of processing corresponding to a request A; and

FIG. 7 is a flowchart showing an acceptance determination process.

### DETAILED DESCRIPTION

With a widespread of APIs in recent years and in the future, it is expected that multiple application software (hereinafter referred to as applications or apps) will access the same vehicle. The vehicle API is an interface for providing vehicle functions to applications implemented inside or outside the vehicle.

Multiple applications are used inside and outside a vehicle. When each of the multiple applications is executed, each application accesses the vehicle at a timing defined within the application. Thus, it may cause a conflict for accessing to the same vehicle. As a result of detailed study by the inventors of the present disclosure, it is found that the conventional technology is a technology for controlling a load within a single system, and therefore it may fail to control the load when there is a competition with other systems.

According to an aspect of the present disclosure, a vehicle control system mounted on a vehicle is provided. The vehicle control system includes at least one vehicle control device and an operation control device. The vehicle control system further includes a first acceptance determination unit, a first output unit, a second acceptance determination unit, and a second output unit.

The first acceptance determination unit is configured to, in response to a first command being input from an application of the at least one vehicle control device, determine whether the first command can be accepted based on resource information. The resource information is related to a processing capacity of resource to be used by the first command. The first output unit is configured to output, in response to the first acceptance determination unit determining that the first command can be accepted, a second command, which is generated based on the first command, to an operation control program that is installed in the operation control device for controlling a control target.

The second acceptance determination unit is configured to, in response to the first acceptance determination unit determining that the first command cannot be accepted, determine whether the first command can be accepted within a predetermined duration based on the resource information. The second output unit is configured to wait until the first command can be accepted and then output the second command to the operation control program in response to the second acceptance determination unit determining that the first command can be accepted within the predetermined duration.

According to the above configuration, when multiple requests are output from multiple applications to access the vehicle functions and some requests cannot be accepted, if the waiting period is within a predetermined period, the system is able to wait until the requests become acceptable. Therefore, it is possible to suppress resource shortage of vehicle within a tolerable range of the vehicle system. Thus, with the above configuration, a conflict among multiple requests, which access vehicle functions from multiple applications, can be avoided.

Hereinafter, embodiments of the present disclosure will be described with reference to the drawings.

### 1. Correspondence Between Configuration of Embodiments and Configuration of Present Disclosure

ECUs 10, 15, 20, 25, 30 in the embodiments correspond to vehicle control devices in the present disclosure. ECUs 41 to 48 in the embodiments correspond to operation control devices in the present disclosure. Each controller 91 to 99 in the embodiments corresponds to an operation control program in the present disclosure.

The process executed in S110 corresponds to the function of first acceptance determination unit in the present disclosure. The process executed in S255 in the embodiment corresponds to the function of first output unit in the present disclosure. The process executed in S150 in the embodiment corresponds to the function of second acceptance determination unit in the present disclosure. The process executed in S410 in the embodiment corresponds to the function of second output unit in the present disclosure. The process executed in S260 and S360 in the embodiment corresponds to the function of determination transmission unit in the present disclosure. The process executed in S130 in the embodiment corresponds to the function of third acceptance determination unit in the present disclosure.

### 2. Configuration

### (2-1. System Configuration)

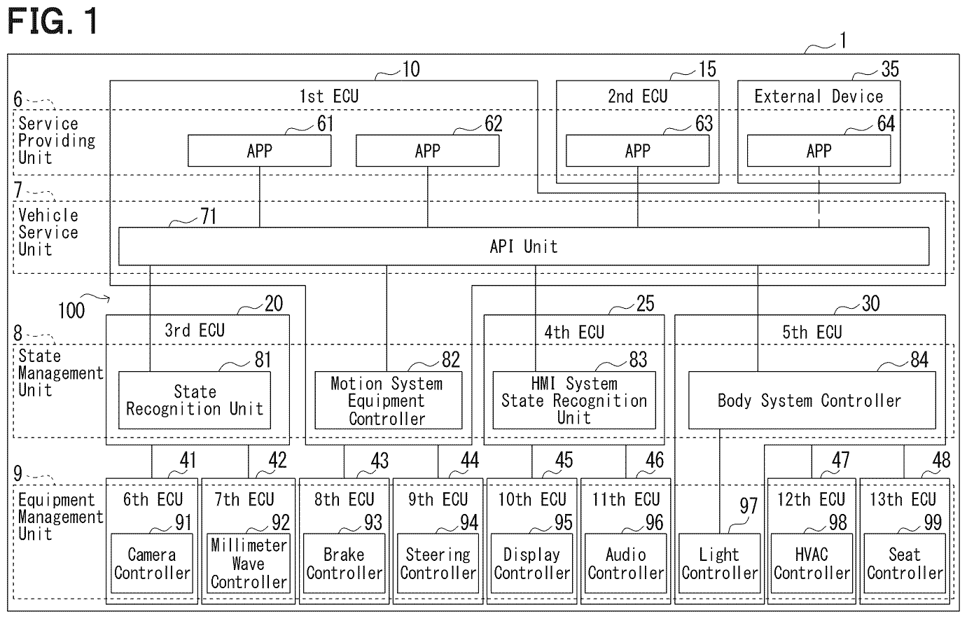

The vehicle control system 1 shown in FIG. 1 includes an electronic control unit (hereinafter referred to as ECU) group 100 mounted on a vehicle such as an automobile. The vehicle control system 1 further includes a center 35 corresponding to an external device. The ECU group 100 includes multiple ECUs. In the present embodiment, the ECU group 100 includes a first ECU 10, a second ECU 15, a third ECU 20, a fourth ECU 25, a fifth ECU 30, and sixth to thirteenth ECUs 41 to 48. The ECUs included in the ECU group 100 are communicably connected to each other via internal vehicle communication (that is, wired communication or wireless communication). The center 35 is provided outside the vehicle and is connected to the ECU group 100 via external vehicle communication (that is, wireless communication).

The first ECU 10 has a relay function for the internal vehicle communication, and controls the second to fifth ECUs 15, 20, 25, 30, thereby performing coordinated control of the entire vehicle. The first ECU 10 also controls communication with the center 35, thereby performing coordinated control of the entire system including the center 35.

The first ECU 10 and the third to fifth ECUs 20, 25, 30 are provided for each of multiple domains, which are divided according to the functions of vehicle in the vehicle. The first ECU 10 and the third to fifth ECUs 20, 25, 30 each mainly performs control of multiple ECUs (that is, the sixth to thirteenth ECUs 41-48) included in the same domain. The multiple domains include, for example, a powertrain, a body, a chassis, a cockpit, or the like.

The sixth to thirteenth ECUs 41 to 48 each controls a vehicle equipment that is an equipment mounted on the vehicle.

The vehicle equipment may include hardware, such as sensors and actuators, as well as various storage devices for storing data and software for implementing certain functions.

The first ECU 10 and the third to fifth ECUs 20, 25, 30 each is connected, via lower layer network, for example, CAN to the lower layer ECUs, which are partial of the sixth to thirteenth ECUs 41 to 48. The CAN is a registered trademark and is an abbreviation for Controller Area Network. The first ECU 10 and the third to fifth ECUs 20, 25, 30 each has a function of centrally managing access rights to the corresponding lower layer ECUs, which is a part of the sixth to thirteenth ECUs 41 to 48, thereby performing user authentication.

In another embodiment, the vehicle control system 1 may include the ECU group 100, and does not include the center 35. In another embodiment, the number of ECUs included in the ECU group 100 may be 14 or more, or 13 or less. In another embodiment, the vehicle control system may include multiple centers 35.

### (2-2. Hardware Configuration)

The following will describe a hardware configuration of each ECU included in the ECU group 100 and a hardware configuration of the center 35. Each ECU included in the ECU group 100 has the same hardware configuration. Accordingly, a configuration of the first ECU 10 will be described below as a representative.

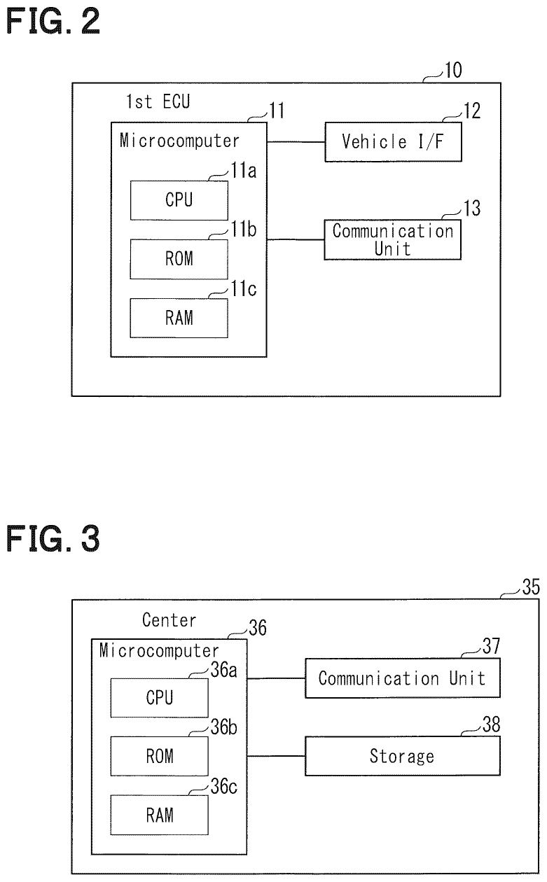

As shown in FIG. 2, the first ECU 10 includes a microcomputer 11, a vehicle interface (hereinafter, referred to as I/F) 12, and a communication unit 13. The microcomputer 11 includes a CPU 11a, a ROM 11b, and a RAM 11c. Various functions of the first ECU 10 are implemented by the CPU 11a executing a program stored in a non-transitory tangible storage medium. In the present embodiment, the ROM 11b corresponds to a non-transitory tangible storage medium that stores the program. A method corresponding to the program is performed when the program is executed.

The vehicle I/F 12 is connected to other ECUs and vehicle-mounted devices via a vehicle network or the like, and acquires various information from other ECUs and vehicle-mounted devices. Vehicle network may include CAN and Ethernet. Ethernet is a registered trademark.

The communication unit 13 performs data communication with the center 35 via a wide area communication network using wireless communication. It is not necessary for all of the ECUs included in the ECU group 100 to have the communication unit 13. For example, only one or partial ECUs may be configured to have the communication unit 13.

The method for implementing the various functions of the first ECU 10 is not limited to software manner. Partial or all of the elements may be implemented using hardware circuitry. For example, when the above functions are implemented by an electronic circuit configured as hardware circuitry, the electronic circuit may be implemented by a digital circuit including large number of logic circuits, an analog circuit, or a combination of digital circuit and analog circuit.

As shown in FIG. 3, the center 35 includes a microcomputer 36, a communication unit 37, and a storage 38. The microcomputer 36 includes a CPU 36a, a ROM 36b, and a RAM 36c. The various functions of the center 35 are implemented by the CPU 36a executing a program stored in a non-transitory tangible storage medium. In the present embodiment, the ROM 36b corresponds to a non-transitory tangible storage medium storing program. A method corresponding to the program is performed when the program is executed.

The communication unit 37 performs data communication with the ECU group 100 via a wide area communication network. The storage 38 is a storage device for storing vehicle data and the like provided by the ECU group 100.

The method for implementing various functions of the center 35 is not limited to software manner. Partial or all of the elements may be implemented using hardware circuitry. For example, when the above functions are implemented by an electronic circuit configured as hardware circuitry, the electronic circuit may be implemented by a digital circuit including large number of logic circuits, an analog circuit, or a combination of digital circuit and analog circuit.

### 3. Functional Configuration

The following will describe various functions of the vehicle control system 1 with reference to FIG. 1. The vehicle control system 1 includes, as functional blocks, an equipment management unit 9 in the first layer, a state management unit 8 in the second layer, a vehicle service unit 7 in the third layer, and a service providing unit 6 in the fourth layer. The software architecture of the vehicle control system 1 is divided into above-described four layers. These layered functions of vehicle control system 1 are executed by the multiple ECUs, which are included in the ECU group 100, and the center 35.

### (3-1. Equipment Management Unit)

The equipment management unit 9 includes multiple controllers 91 to 99 corresponding to multiple types of vehicle equipment. The multiple types of vehicle equipment include, for example, a vehicle-mounted camera, a vehicle-mounted millimeter wave radar, brake, steering, display, speaker, various lights, vehicle-mounted air conditioner, electric power seat, and the like.

Specifically, the equipment management unit 9 includes a camera controller 91, a millimeter wave controller 92, a brake controller 93, a steering controller 94, a display controller 95, an audio controller 96, a light controller 97, a heating ventilation and air-conditioning (hereinafter referred to as HVAC) controller 98, and a seat controller 99.

The vehicle equipment is individually controlled by a corresponding controller, which is one of the controllers 91 to 99.

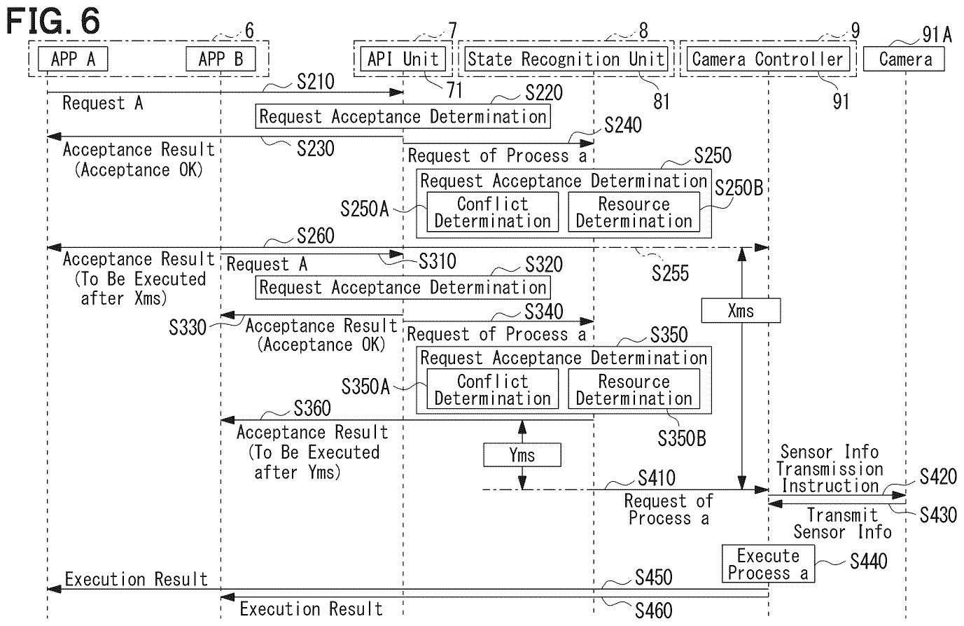

A camera controller 91 controls an exposure of on-board camera (for example, a camera 91A shown in FIG. 6), and acquires an image captured by the on-board camera. In the present embodiment, the sixth ECU 41 includes the camera controller 91.

A millimeter wave controller 92 controls an on-board millimeter wave radar, and acquires detection results detected by the millimeter wave radar. In the present embodiment, the seventh ECU 42 includes the millimeter wave controller 92.

A brake controller 93 controls a brake. In the present embodiment, the eighth ECU 43 includes the brake controller 93.

A steering controller 94 controls steering of the vehicle. In the present embodiment, the ninth ECU 44 includes the steering controller 94.

A display controller 95 controls display devices (for example, meters, warning lights, or the like). In the present embodiment, the tenth ECU 45 includes the display controller 95.

An audio controller 96 controls a speaker to output a sound, such as warning sound or a voice. In the present embodiment, the eleventh ECU 46 includes the audio controller 96.

A light controller 97 controls various lights mounted on the vehicle. In the present embodiment, the fifth ECU 30 includes the light controller 97.

An HVAC controller 98 controls an in-vehicle air conditioner. In the present embodiment, the twelfth ECU 47 includes the HVAC controller 98.

A seat controller 99 controls an electric power seat of the vehicle. In the present embodiment, the thirteenth ECU 48 includes the seat controller 99.

The equipment management unit 9 operates the vehicle equipment in accordance with an operation instruction output from the state management unit 8, and notifies the state management unit 8 of the operation result. For example, when the vehicle equipment is an actuator, the operation result may indicate an operation of the actuator is completed normally or abnormally. When the vehicle equipment is a sensor, the operation result may indicate data detected by the sensor. When the vehicle equipment is a storage device, the notified result may include data read from the storage device.

The equipment management unit 9 may be configured to operate the vehicle equipment in accordance with an operation instruction output from the state management unit 8, as well as to automatically detect the state of vehicle equipment and notify the detected state of vehicle equipment to the state management unit 8.

### (3-2. Service Providing Unit)

The service providing unit 6 executes the applications 61 to 64 to provide various functions, such as information collection, theft prevention, and remote control, by utilizing the vehicle equipment, which is managed by the equipment management unit 9.

In the present embodiment, the first ECU 10, the second ECU 15, and the center 35 are provided with the service providing unit 6. The ROM 11b of the first ECU 10 stores the applications 61 and 62. The ROM 11b of the second ECU 15 stores the application 63. The ROM 36b of the center 35 stores the application 64.

The applications 61 to 64 are basically configured to provide the intended services by utilizing the functions of vehicle equipment via an API unit 71, which constitutes the vehicle service unit 7 and is also referred to as vehicle API. API is an abbreviation for Application Programming Interface.

The applications 61 to 64 each is not program for executing a process compatible with a specific vehicle type, a specific grade, or the like. The applications 61 to 64 each is a general-purpose program for executing a process compatible with different vehicle types, different vehicle grades or the like. Therefore, the applications 61 to 64 is described using functions of a modeled vehicle that is publicly available so that the applications can be developed without considering the vehicle equipment and performance of individual vehicles. The applications 61 to 64 can be easily developed by third parties who are application providers other than the OEM. Further, the developed products can be widely released. Therefore, a vehicle user who owns a vehicle equipped with the ECU group 100 can install an application released by a third party into any ECU included in the ECU group 100 via a wide area communication network or the like. The vehicle user can add or change the applications 61 to 64 as necessary.

An application may be used to provide a service that acquires vehicle information from multiple vehicles and analyzes vehicle behavior and driving operations by the driver, or the like. In this case, a service provider that provides the application may install the application in one ECU of the ECU group 100 after getting a permission of vehicle user. The access authority for accessing each API included in the API unit 71 from an application installed in the center 35 by a service provider or the like may be restricted by the vehicle user, for each service provider or for each application.

### (3-3. Vehicle Service Unit)

The vehicle service unit 7 includes the API unit 71. In the present embodiment, the API unit 71 is included in the first ECU 10. The API unit 71 includes multiple vehicle APIs. The vehicle API is an interface provided to each application 61 to 64, which is included in the service providing unit 6, for accessing the subdivided functions of the vehicle.

The vehicle API has a standardized syntax that allows requests to be written without depending on a specific vehicle type or grade. When using a function provided by the vehicle, the applications 61 to 64 each transmits a first command using the vehicle API. The first command indicates information required for using the vehicle API.

The first instruction may include a command indicating required content, an instruction such as an argument, a function call, or the like. The first command may also include priority information indicating which command should be processed with priority. The priority may be set, for example, different in a case where the manufacturer of application, which is the request source of first command is OEM, from a case where the manufacturer of application is a third party other than the OEM. OEM is an abbreviation for original equipment manufacturer. Specifically, OEM may be set to have a higher priority than third party. Among multiple OEMs, vehicle manufacturers may be set to have a higher priority than a manufacturer of vehicle parts or a manufacturer of applications. The priority may be set according to the type of control.

The syntax of vehicle API, that is, the format of first command is written using publicly available modeled vehicle functions, similar to the applications 61 to 64, so that the vehicle API can be developed without considering the vehicle equipment and performance of individual vehicles. The first command describes the function to be executed in abstract manner without specifying the vehicle equipment or using expressions that depend on the performance of vehicle equipment. For example, the first command describes that a car finder should be turned on, but does not describe specific equipment that may be different in different vehicles. For example, the first command does not describe which vehicle equipment should be controlled and how the vehicle equipment should be controlled, such as specifying which light to turn on out of multiple lights installed in the vehicle.

When receiving the first command, the API unit 71 determines whether the first command can be accepted from a formal perspective, such as the format of first command and an access authority of request source that requests the first command. When the API unit 71 determines that the first command is acceptable, the API unit converts the first command into a second command described in a format that is compatible with the type and grade of the target vehicle. Then, the API unit sends the second command to the state management unit 8. The API unit 71 has the function of converting the first command, which is described in a standard format compatible with the service providing unit 6, into the second command, which is described in a format specific to the vehicle to be managed by the state management unit 8 and the equipment management unit 9. The second command is assigned with an application ID that identifies transmission source application of the first command (hereinafter, referred to as request application). The API unit 71 also has a function of transferring a result notification, which is a response from the state management unit 8 to the second command, to the transmission source application that has transmitted the request.

The API unit 71 includes a function API 72, a confirmation API 73, and a reservation API 74.

The function API 72 is a vehicle API that requests a control of vehicle equipment.

The confirmation API 73 is a vehicle API that confirms an available time period for the specified function API 72.

The reservation API 74 is a vehicle API that reserves the use of specified function API 72 by specifying a start condition, an end condition, or the like.

### (3-4. State Management Unit)

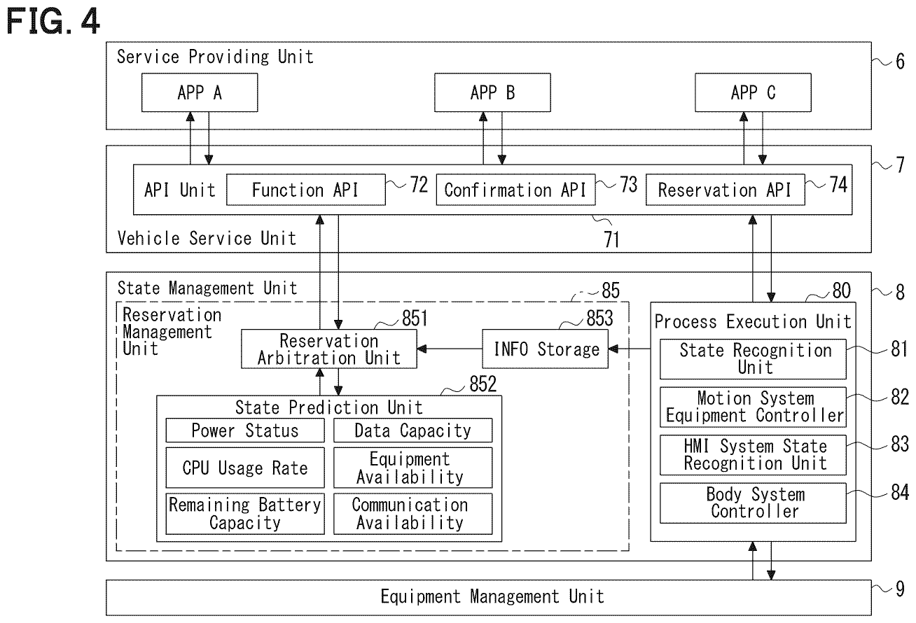

As shown in FIG. 4, the state management unit 8 includes a process execution unit 80 and a reservation management unit 85.

The process execution unit 80 processes a request from the service providing unit 6 via the function API 72.

The reservation management unit 85 processes a request from the service providing unit 6 via the confirmation API 73 and the reservation API 74.

### (3-4-1. Process Execution Unit)

The process execution unit 80 includes a state recognition unit 81, a motion system equipment controller 82, a Human Machine Interface (hereinafter referred to as HMI) system state recognition unit 83, and a body system controller 84.

The state recognition unit 81, the motion system equipment controller 82, the HMI system state recognition unit 83, and the body system controller 84 included in the process execution unit 80 are classified according to the vehicle operation that the service providing unit 6 is likely to request, rather than according to the implementation device (for example, controllers 91 to 99) that are likely to depend on vehicle variations. In the present embodiment, as shown in FIG. 1, the state recognition unit 81, the motion system equipment controller 82, the HMI system state recognition unit 83, and the body system controller 84 of the process execution unit 80 are provided in one of the first ECU 10 and the third to fifth ECU 20, 25, 30, which manage respective domains of the vehicle.

The state recognition unit 81 recognizes a state of the vehicle and a state of the surrounding of vehicle, such as the positions of vehicle and pedestrians. The state recognition unit 81 controls, for example, vehicle equipment corresponding to the camera controller 91 and the millimeter wave controller 92. In the present embodiment, the third ECU 20 includes the state recognition unit 81.

The motion system equipment controller 82 controls vehicle operation related to traveling, such as turning, traveling, and stopping. The motion system equipment controller 82 controls, for example, vehicle equipment corresponding to the brake controller 93 and the steering controller 94. In the present embodiment, the first ECU 10 includes the motion system equipment controller 82.

The HMI system state recognition unit 83 controls vehicle operation related to the presentation of information to the user. The HMI system state recognition unit 83 controls, for example, vehicle equipment corresponding to the display controller 95 and the audio controller 96. In the present embodiment, the fourth ECU 25 includes the HMI system state recognition unit 83.

The body system controller 84 controls the vehicle operation related to body system according to the vehicle environment. The body system controller 84 controls vehicle equipment corresponding to the light controller 97, the HVAC controller 98, and the seat controller 99. In the present embodiment, the fifth ECU 30 includes the body system controller 84.

When the process execution unit 80 receives a request (that is, the second command) from the vehicle service unit 7, the process execution unit determines whether the vehicle state is suitable for executing the second command. In response to determining that the vehicle state is suitable for executing the second command, the process execution unit instructs the equipment management unit 9 to operate the target equipment. The vehicle state suitable for executing the second command may include (i) the target equipment being capable of performing the function required by the second command and (ii) the execution of second command not being prohibited in a scene estimated from the vehicle state.

The process execution unit 80 has the function of outputting an operation instruction for the target equipment to the equipment management unit 9 and providing the operation result returned from the equipment management unit 9 to the vehicle service unit 7 as a result notification in response to the second command. The result notification may use the individual operation results as they are, or may integrate individual operation results and convert the integrated result into highly abstract data.

Suppose that the process execution unit 80 receives a request from the vehicle service unit 7 to collect information to specify the vehicle state. In this case, the process execution unit obtains data from multiple vehicle equipment, as the operation result of equipment management unit 9. When data such as “vehicle speed 0 km/h,” “shift position P,” and “driver not in the vehicle” are acquired as the operation result, the multiple piece of data may be converted into data indicating that “vehicle in parked state,” and the converted data may be sent to the vehicle service unit 7 as the result notification.

### (3-4-2. Reservation Management Unit)

The reservation management unit 85 may be provided in the third ECU 20 as an example. Alternatively, the reservation management unit 85 may be provided in another ECU rather than the third ECU 20. As shown in FIG. 4, the reservation management unit 85 includes a reservation arbitration unit 851, a state prediction unit 852, and an information storage 853.

The information storage 853 stores resource information and reservation information.

The resource information is information that associates an API-ID that identifies a function API 72 with a resource required to execute a process associated with the corresponding function API 72. The resource information includes processing capabilities of the operation control devices (for example, various ECUs) to process requests from the applications 61 to 64. In some cases, multiple resources may be provided. When multiple resources are provided, multiple resources are referred to as resources. The resources may include processing capabilities of resources (e.g., devices and equipment) mounted on the vehicle. The resources include, for example, a CPU, storage, memory, battery, communication equipment, sensors, actuators, and the like. The resource information may include past, present, and future usage of these resources.

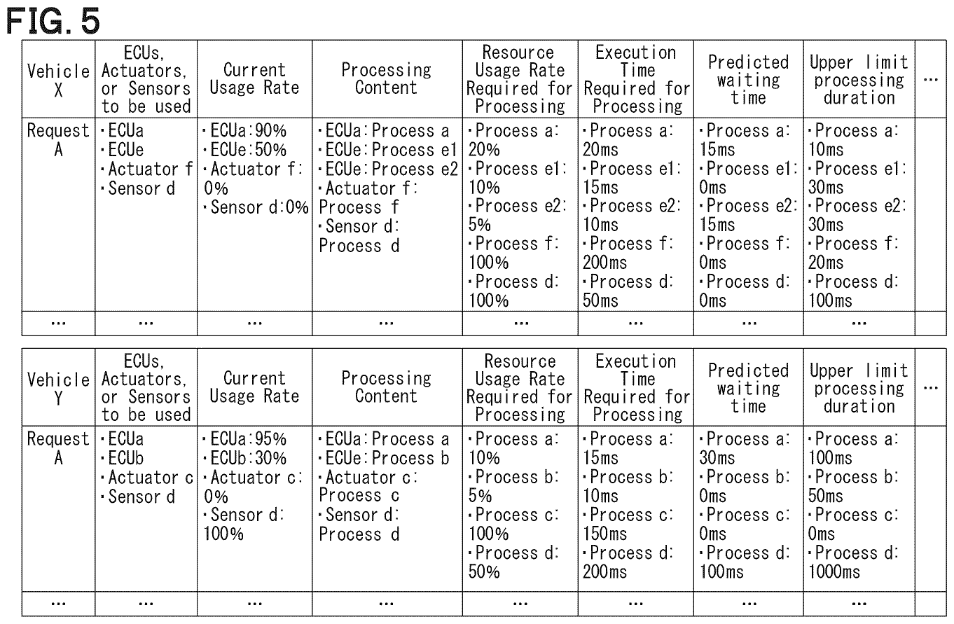

The resource information required for executing the process is stored in each vehicle, and this data is different from another vehicle. The resource information includes characteristic information that differs depending on the vehicle type or individual vehicle. As shown in FIG. 5, the resource information of vehicle X and the resource information of vehicle Y, as characteristic information, are set to have different values.

In each vehicle, the resource information may be stored in the information storage 853. The information storage 853 stores the past, present, and future (future) usage state of each resource as characteristic information, or as a table separate from the characteristic information. The past, present, and future usage state of each resource can be read and rewritten by the reservation arbitration unit 851.

The resource information required to execute the process includes information such as “ECUs, actuators, or sensors to be used,” “current usage rate,” “processing content,” “resource usage rate required for processing,” “execution time required for processing,” “predicted waiting time,” and “upper limit processing duration.”

The “ECUs, actuators, and sensors to be used,” “processing content,” “resource usage rate required for processing,” and “execution time required for processing” are predetermined static objects or values. The “execution time required for processing” may be a value calculated for each time execution.

The “ECUs, actuators, and sensors to be used” indicate the ECUs that execute the processing, the actuators or sensors corresponding to the processing targets. Hereinafter, the processing target is also referred to as usage equipment. The “current usage rate” indicates the usage rate for each usage equipment. The usage rate is the usage rate of a resource, that is, the rate at which the resource has been used. The usage rate mainly indicates the usage rate of ECU installed in each of the controllers 91 to 99, and may also include the status of each ECU mounted on the vehicle.

The “processing content” indicates a processing to be executed by each usage equipment. The “resource usage rate required for processing” indicates the usage rate of resource required for each processing to be executed. The “execution time required for processing” indicates the time required from the start to the end of each processing to be executed. The “predicted waiting time” indicates, for each processing to be executed, the start time of processing in the future, specifically, how many milliseconds after which the process can be executed. That is, future resource information is included in the predicted waiting time. The “upper limit processing duration” indicates the upper limit of duration within which a process must be completed, and is set for each process to be executed. The upper limit processing duration is specified for each request. The “current usage rate” may be periodically acquired, and updated when acquired.

The reservation information is information related to use reservation of function API 72. The reservation information is set in accordance with a request from the service providing unit 6, which uses the reservation API 74. The reservation information includes the function API 72 that identifies the reservation target function API 72, an application ID of an application that requests the reservation, start time and end time of reservation, and the like.

In response to an inquiry from the reservation arbitration unit 851, the state prediction unit 852 responds a predicted usage state of the vehicle equipment (that is, resource). The target period of prediction may be set to a specified time range (for example, 24 hours) from the time when the request is accepted, or the target period of prediction may be set to a time range specified by the instruction from the reservation arbitration unit 851. The resource information to be predicted includes the aforementioned “predicted waiting time,” and may also include “power status,” “future usage rate prediction,” “remaining battery capacity,” “free data capacity,” “equipment availability,” “communication availability,” or the like.

The “power status” may include information indicating whether the IG is in ON, ACC, or OFF state, as well as information indicating a connection state of charging plug. The “future usage rate prediction” may include CPU usage rate. The “predicted waiting time” is obtained by the state prediction unit 852. In response to receiving an inquiry from the reservation arbitration unit 851, by referring to the information storage 853, the state prediction unit 852 calculates the waiting time based on the sum of required execution durations of one or more other processes in standby state. The “future usage rate prediction” indicates the usage rate of CPU installed in each controller 91 to 99 in percentage. The “future usage rate prediction” may include information on the usage rate of CPU mounted in an ECU other than the ECUs included in the controllers 91 to 99. The “remaining battery capacity” indicates the remaining capacity of the vehicle battery in percentage. The “free data capacity” indicates the free memory capacity available for processing. The “equipment availability” indicates a result of determination whether the equipment is available for use. Whether the equipment is available for use may include whether the equipment has an anomaly or whether the equipment is in operation state or not. The equipment for which “equipment availability” is indicated may be configured to perform high load processing, such as an image processing. The “communication availability” indicates a communication status with an external server. For example, an occupancy rate of a communication channel used for the communication with the external server may be indicated for each application.

The state prediction unit 852 repeatedly acquires the state of vehicle-mounted equipment from the equipment management unit 9 and accumulates the results in a predetermined aggregation method. The aggregation method may count the elapsed period from the start time point, which is the time when the IG switch of the vehicle is turned on or off, as an index. The aggregation value may be calculated individually for each day of the week, each season, or each driver.

When the state prediction unit 852 receives an inquiry from the reservation arbitration unit 851, the state prediction unit predicts the usage state of each resource and returns the prediction result to the reservation arbitration unit 851. The usage state of each resource is predicted with consideration of the aggregated value of past usage state and reservation information stored in the information storage 853. The usage state of each resource may be predicted using information, such as whether each application has access right to each API, a traveling route set by the navigation device, a distance to a destination, and estimated time of arrival. Prediction of usage state for each resource may use information, such as predicted alighting extracted from images captured by a camera that captures images inside the vehicle compartment, or information about the driver's schedule obtained by linking with the calendar on a mobile terminal of the driver. The usage state of each resource may be predicted using past prediction result, whether or not the air conditioner is being used, and the like.

The following will describe a method for predicting the usage state of source by the state prediction unit 852.

For “power status,” when the current power status is IG-ON or the charging plug is in connected state, the probability that the current power status is IG-ON is set to 100%, and the predicted value S1 is gradually reduced with elapse of time.

There are two methods for reducing the predicted value S1. First is a method for simply reducing the predicted value in inverse proportion to the elapse of time, as shown in mathematical formula (1). Second is a method for reducing the predicted value in accordance with a preset first table value f1(t), as shown in mathematical formula (2). In the formulas, t represents time, and f1(t) takes a value within a range of 0 to 1. f1(t) is set such that the value changes with the elapse of time.

S1[%]=100/t (1)

S1[%]=100×f1(t) (2)

The first table value f1(t) may be set based on past history. In this case, the first table value f1(t) may be set to monotonically decrease over a calculated average time until the value of first table value f1(t) reaches almost zero. The average time may be calculated, based on the past history, from when the IG is turned on until when the IG is turned off.

When the current power status is IG-ON and the traveling route is set by the navigation device, the first table value f1(t) may be set to a small value up to the estimated arrival time in the route guidance of navigation device, and to a large value after the estimated arrival time.

When the current power status corresponds to that the charging plug is in connected state, the first table value f1(t) may be set to a small value until the scheduled charging completion time according to the charging plan, and to a large value after the scheduled charging completion time.

The predicted value S2 of “future usage rate prediction” may be calculated according to mathematical formula (3) using a second table value f2(t). The second table value represents the CPU usage rate predicted from the application usage record or the application usage plan. The second table value f2(t) takes a value within a range of 0 to 1.

S2[%]=100×f2(t) (3)

When setting the second table value f2(t) from the usage history of application, the usage history of application is aggregated on a time axis representing the elapsed time from the time when IG was turned ON, and the probability that each application will be used at a specific time is calculated. The second table value f2(t) is set based on this probability and the CPU usage rate when each application is used. The second table value f2(t) may be set individually for each application.

The second table value f2(t) may be set using an application usage plan instead of the actual application usage record.

The predicted value S3 of “remaining battery capacity” may be calculated according to a mathematical formula (4) using the current remaining battery capacity Qc [%] as a reference and using a third table value f3(t). The third table value f3(t) is set based on the application usage history or application usage plan and the power consumption required by each application.

S3[%]=Qc−100×f3(t) (4)

The third table value f3(t) is set such that the amount of attenuation increases (i) as the probability that an application will be used at each time point increases or (ii) as the power consumption of application increases. When the traveling route is set by the navigation device, the third table value f3(t) may be set in consideration of the usage state of application predicted from the traveling route.

The predicted value S4 of “free data capacity” may be calculated according to the mathematical formula (5) using a fourth table value f4(t). The fourth table value f4(t) is set based on the (i) application usage history or usage plan and (ii) the data capacity required by each application when executing a process, with the maximum value of available data capacity being Dm.

S4[%]=Dm×f4(t) (5)

The fourth table value f4(t) is set based on the probability of each application being used at each time point and the data capacity required when each application is executed. The probability of each application being used at each time point is calculated from the aggregation result of application usage recorded on a time axis representing the elapsed time starting from the time when the IG was turned ON. Instead of the actual usage record of application, a usage plan of application may be used in setting of the fourth table value.

The predicted values S5 and S6 of “equipment availability” may be calculated, respectively, using a fifth table value f5(t) and a sixth table value f6(t). The fifth table value f5(t) and the sixth table value f6(t) are set based on the usage history or usage plan of equipment that may be accessed by multiple applications (for example, camera, special image processing, or the like). The predicted value S5 indicates a probability that the equipment is not in use and available, and may be calculated according to the mathematical formula (6). The predicted value S6 indicates a probability that the equipment is in use and is not available, and may be calculated according to the mathematical formula (7).

S5[%]=100×f5(t) (6)

S6[%]=100×f6(t) (7)

The predicted value S7 of “communication availability” may be calculated using the mathematical formula (8) with the current communication state as C [%]. The predicted value S7 may also be calculated using the mathematical formula (9) with the seventh table value f7(t) representing the communication state estimated from the vehicle's traveling plan. The current communication state C may be, for example, the ratio of actually measured communication speed to the maximum communication speed. The seventh table value f7(t) takes a value within a range of 0 to 1.

S7[%]=C/t (8)

S7[%]=100×f7(t) (9)

When the traveling route is set by the navigation device, the seventh table value f7(t) may be set to a smaller value depending on the surrounding environment of the traveling route, for example, at the scheduled time of passing through a tunnel or a group of buildings, where the communication conditions is estimated to deteriorate.

The first to seventh table values f1(t) to f7(t) may be prepared individually for each season, each time period, or each driver.

The reservation arbitration unit 851 executes an acceptance determination process for processing a request transmitted from the service providing unit 6 via the confirmation API 73 or the reservation API 74 of the API unit 71.

### 4. Process

### (4-1. Sequence Diagram)

The following will describe a basic process executed by the vehicle control system 1 with reference to a sequence diagram shown in FIG. 6. As a specific example of operation, FIG. 6 shows an example in which application A and application B transmit request A to the API unit 71, and cause the camera controller 91 to execute a process a using camera 91A.

In S210, the service providing unit 6 transmits a request A (for example, a first command in the present disclosure) to the vehicle service unit 7, specifically, to the API unit 71. Then, the vehicle service unit 7 executes a request acceptance determination in S220. The request acceptance determination executed by the vehicle service unit 7 is a process of determining whether each of the controllers 91 to 99 is capable of accepting the first command.

In S220, the vehicle service unit 7 determines whether the first command can be accepted based on at least one of the vehicle equipment, the vehicle state, or the syntax of command included in the first command. Note that the vehicle equipment indicates the state of vehicle to which the vehicle control system 1 is equipped, and the vehicle state indicates the state of vehicle to which the vehicle control system 1 is equipped.

In S220, the vehicle service unit 7 determines whether the operation request from the service providing unit 6 can be accepted based on, for example, the following six items.
(1) Syntax: Whether an error exists in the API syntax of program.
(2) Equipment information: Whether the vehicle is equipped with the control target required to operate.
(3) Operation possible level: Whether the equipment required to operate can currently accept the operation request.
(4) Authentication or Authorization: Whether the service providing unit 6 corresponding to request source is authenticated, and whether the service providing unit 6 has an access right to the vehicle service unit 7.
(5) Abnormality in vehicle service unit 7: Whether an abnormality (for example, a data or communication abnormality, an operation other than specified normal operation, and the like) has occurred in the vehicle service unit 7.
(6) Cache state: After the state management unit 8 determines that the command cannot be accepted, whether a period of time for enabling acceptance of same command is elapsed.

Note that in item (3), the state of “equipment can accept” indicates that the operation request range is within a predetermined range or the number of possible requests within a certain period is within a predetermined range. The number of possible requests within the predetermined range indicates the number of requests accepted during a predetermined period of time is within the predetermined range. In item (3), the operation request that does not match the vehicle state is rejected. For example, during traveling at 100 km/h, a request to open the door is rejected.

In item (5), whether to cache the unacceptable information for each request source or whether to cache the unacceptable information regardless of the request source may be set depending on the combination of vehicle API 71 and the unacceptable contents.

The determination items may be properly set for each vehicle API 71 in the vehicle service unit 7. That is, determination may be omitted for some of the above-described items. The RAM 11c stores information on the equipment provided in the vehicle, the authentication state and access right of the service providing unit 6, the current vehicle state related to the equipment, and abnormality information of vehicle service unit. Additionally, the RAM 11c also stores information, such as cache state information that the vehicle service unit 7 refers to when determining whether to accept a request.

In S230, the vehicle service unit 7 transmits, to the service providing unit 6, the determination result indicating whether the first command can be accepted or not. In S240, the vehicle service unit 7 transmits, to the state management unit 8, a request of process a. The request of process a is a request to execute the process a. The request of process a is transmitted only when the first command can be accepted.

When the state management unit 8 receives the request of process a from the vehicle service unit 7, the state management unit 8 determines whether the request is to be accepted in S250. The request acceptance determination executed by the state management unit 8 includes a conflict determination in S250A and a resource determination in S250B. In the conflict determination, the state management unit 8 determines whether the first command can be accepted in consideration of the conflict between the first command and another command. Another command is a command different from the first command and the second command, and is a command sent from an application different from the application that has sent the first command. The state management unit 8 may determine whether the request can be accepted, with consideration of a competition between a request accepted by the API 71 and a request accepted by another API (for example, another vehicle API) that is different from the API (for example, the vehicle API 71) that has accepted the request.

The above-mentioned operation request acceptance determination refers to the vehicle state, and determines whether the operation request can be accepted regardless of other commands. The conflict determination in S250B determines whether the operation request can be accepted with consideration of conflict with another command.

For example, the state management unit 8 determines whether the operation request can be accepted or not based on the following five items.
(1) Request priority arbitration: Whether the first command has a higher priority than request from another application or another user operation.
(2) Cancellation request by request source: Whether the request source has requested cancellation of the request and whether the request is being processed.
(3) Cancellation request by user: Whether a stop request by user has occurred.
(4) Request processing overload: Whether the number of multiple requests accepted by the control target is equal to or more than the possible processing number.
(5) Abnormality in state management unit 8 or in equipment management unit 9: Whether an abnormality (for example, data or communication abnormality, an operation other than specified normal operation) has occurred in the state management unit 8 or in the equipment management unit 9.

In item (1), the priority is specified by the application, and the operation based on the priority is determined by the receiving side. Alternatively, the receiving side may ignore the priority specified by the application when performing the operation.

For example, when the state management unit 8 receives a request to turn on an air conditioner and a request to turn on a light, the voltage may decrease to a level lower than an electrically allowable threshold if both of the two requests are accepted. In this case, the state management unit 8 determines that both requests cannot be accepted. When the state management unit 8 receives a request related to acceleration and a request related to steering, the vehicle drive control amount that satisfies both requests may cause the vehicle to deviate from the traveling road or lane. In this case, the state management unit 8 determines that both requests cannot be accepted. The priority information for each request, information related to cancellation by request source, information related to cancellation by user, and threshold values that can be processed by the control target (for example, number of requests, control amount, processing load) are stored in the RAM 11c or other memories. The information that the state management unit 8 refers to when determining acceptance of request, such as abnormality information of the state management unit 8 or the equipment management unit 9 is stored in the RAM 11c or other memories. In response to determining that the request is not acceptable as a result of competition determination, a message indicating that the request is not acceptable is transmitted in S260 as shown in FIG. 6.

After the conflict determination in S250A, the state management unit 8 performs the resource determination in S250B. The conflict determination and the resource determination may be selectively performed depending on the process to be executed. The resource determination may be performed only when the request is determined to be acceptable by the conflict determination. When the state management unit 8 determines in the resource determination that the process a is executable, the state management unit 8 generates a second command, which specifies the abstract first command, as an operation instruction and transmits the second command.

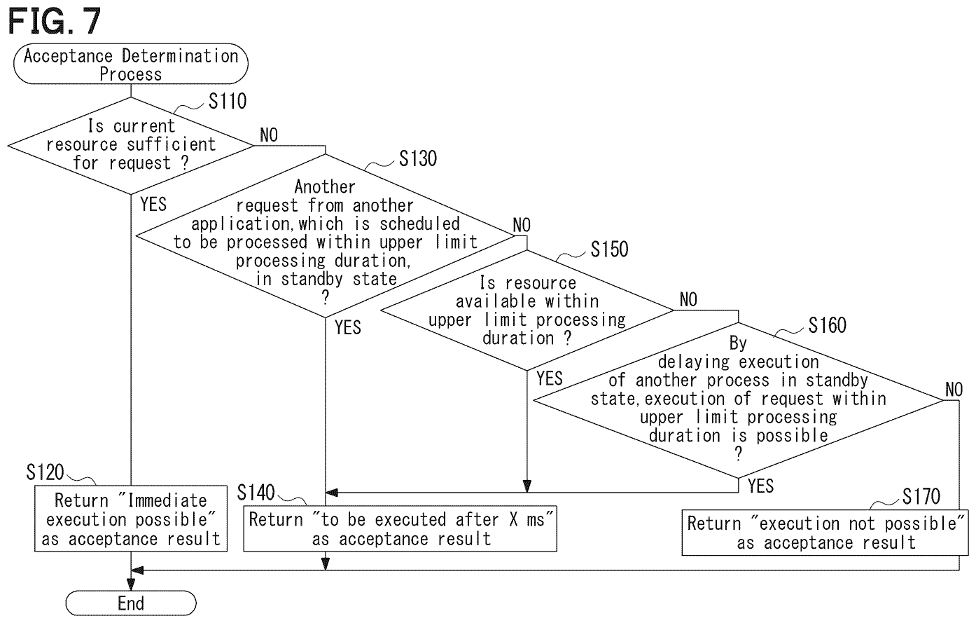

The resource determination is a process executed by the reservation arbitration unit 851 of the state management unit 8, and corresponds to the acceptance determination process shown in FIG. 7. The acceptance determination process will be described with reference to the flowchart of FIG. 7. The acceptance determination process starts in response to receiving the second command from the vehicle service unit 7.

When the acceptance determination process is started, in S110, the reservation arbitration unit 851 determines whether there is sufficient resource at current time to execute the command accepted in S240 (hereinafter also referred to as “current request”). For example, the reservation arbitration unit determines whether the processing capacity of operation control device (for example, the controller 91 to 99) is sufficient to process the request from the application.

At this time, the reservation arbitration unit 851 refers to the required resource information stored in the information storage 853 and acquires information about the resource (hereinafter referred to as required resource) required to execute the API of confirmation target. The required resource corresponds to the “current usage rate” and the “resource usage rate required for processing”. When the sum of these two rates does not exceed 100%, the current resource is determined to be sufficient. When the sum of two rates exceeds 100%, the current resource is determined to be insufficient.

When the reservation arbitration unit 851 determines that the current resource is sufficient, the process proceeds to S120. When the reservation arbitration unit 851 determines that the current resource is not sufficient, the process proceeds to S130.

In S120, the reservation arbitration unit 851 sends a notification that the request can be executed immediately as an acceptance result to the request source application via the API unit 71 (refer to S260 in FIG. 6). In this case, the reservation arbitration unit 851 requests the equipment management unit 9 to immediately execute the process, as shown in S255 of FIG. 6. After S120 is executed, the process is ended.

In S130, the reservation arbitration unit 851 determines whether the processing for the current request is scheduled to be executed within the upper limit processing duration based on a request from another application. That is, the reservation arbitration unit 851 is configured to determine whether it has accepted the same type of first command (that is, the second commands corresponding to the same type of first command are the same with one another) from the second application while the reservation arbitration unit waits until the acceptance of first command become available. When the application that transmitted the first command is defined as the first application, the second application is an application different from the first application. When the current request is same as a request from another application, the process determines whether to integrate the same multiple requests and execute the multiple requests as a single process in order to save resource and improve efficiency.

The information indicating that the process is in standby state waiting to be executed and the upper limit processing duration are stored in the information storage 853 in advance. When determining the integrated processing of multiple requests, the reservation arbitration unit 851 reads out the information indicating that the process is in standby state waiting to be executed and the upper limit processing duration, from the information storage 853.

When the process for current request is scheduled to be executed within the upper limit processing duration of a request from another application, the reservation arbitration unit 851 proceeds to S140. At this time, the reservation arbitration unit 851 calculates a period from the current time to a start time of process corresponding to a request from another application, and sets this period as a standby duration (that is, X ms). When the processing for the current request is not scheduled to be executed within the upper limit processing duration based on a request from another application, the process proceeds to S150.

In S140, the reservation arbitration unit 851 sends a notification to the request source application via the API unit 71 as an acceptance result. The notification may indicate that the request can be executed after X ms (as shown in S260 of FIG. 6). That is, information indicating the duration until the first command can be accepted is transmitted to the request source application. As the information indicating the duration, the waiting time calculated by the reservation arbitration unit 851 is used. In this case, as shown in S410 of FIG. 6, after waiting for the duration of X ms, a request is made to the equipment management unit 9 to execute the process. After execution of S140, the process is ended.

In S150, the reservation arbitration unit 851 determines whether resource is available within the upper limit processing duration, allowing the execution of process. For example, when another process is completed and a process corresponding to the current request can be executed, this situation corresponds to an example of surplus of resource, that is, resource is available. There may be a case where resource become available due to changes in the environment, such as improved radio wave conditions.

In S150, for each process executed corresponding to a request, when the sum of “execution time required for processing” and the “predicted waiting time” is less than or equal to the “upper limit processing duration”, the process is determined to be executable. For example, request A for vehicle X shown in FIG. 5 is determined to be executable for the process e1 because the sum of “execution time required for processing” and “predicted waiting time” is 15 ms, and the “upper limit processing duration” is 30 ms. For the process a, the sum of “execution time required for processing” and “predicted waiting time” is 35 ms, and the “upper limit processing duration” is 10 ms, so it is determined that process a cannot be executed.

The reservation arbitration unit 851 makes a positive determination when all of the processing that should be performed for the request (for example, request A) can be performed, and makes a negative determination when some of the processing that should be performed for the request cannot be performed.

At this time, the reservation arbitration unit 851 inquires of the state prediction unit 852, and acquires the “predicted waiting time.” When there is a surplus of resource within the upper limit processing duration and processing of the current request can be executed, the reservation arbitration unit 851 proceeds to S140. At this time, the reservation arbitration unit 851 calculates the duration from the current time until the processing corresponding to the current request can be started since there is a surplus of resource, and sets this duration as the standby duration (X ms). When there is no surplus of resource within the upper limit processing duration and processing for the current request cannot be executed, the process proceeds to S160.

In S160, the reservation arbitration unit 851 determines whether the processing for the current request can be executed within the upper limit processing duration by delaying the start of another process that is currently in standby state. Note that the start of another waiting process is delayed under a condition that the waiting process is executed within the upper limit processing duration.

When the reservation arbitration unit 851 determines that the processing for current request can be executed within the upper limit processing duration by delaying a start of another process that is currently in standby state, the process proceeds to S140. At this time, the reservation arbitration unit 851 calculates the duration from the current time until the processing corresponding to the current request can be started since there is a surplus of resource, and sets this duration as the standby duration (X ms). For another process whose start time has been changed, the changed start times is notified. When the reservation arbitration unit 851 determines that the processing for current request cannot be executed within the upper limit processing duration even though the start of another process currently on standby state is delayed, the process proceeds to S170.

In S170, the reservation arbitration unit 851 sends a notification (see S260 of FIG. 6) indicating that the request is “unacceptable” as the acceptance result, to the request source application of current request, via the API unit 71. After execution of S170, the process is ended.

The process executed in S310 to S360 of FIG. 6 shows an example in which request A is sent from the application B. In S310, a request A to execute the same process a is sent from a different application. In S310 to S360, the same processing as in S210 to S260 described above is executed.

The request A from application B is integrated with the request A from application A that is waiting for process a, and is executed as one process a. In this case, the waiting time in the reservation arbitration unit 851 for request A from application A is X ms, whereas the waiting time in the reservation arbitration unit 851 for request A from application B is Y ms, which is shorter than X ms.

As described above, the reservation arbitration unit 851 outputs the second command based on the first command to each of the controllers 91 to 99 of the equipment management unit 9 in S255 or S410.

Each of the controllers 91 to 99 is equipped with an operation control program for operating the control target. Each of the controllers 91 to 99 in the equipment management unit 9, in response to receiving the operation instruction, executes the operation control program. Upon receiving a request, each of the controllers 91 to 99 transmits an operation instruction to the control target. In the example of FIG. 6, the camera controller 91 in the equipment management unit 9 receives the request of process a and transmits a sensor information transmission instruction to the camera 91A in S420. When the camera 91A receives the instruction to transmit sensor information, the camera returns the sensor information, such as images captured by the camera 91A, to the camera controller 91. Then, in S440, the camera controller 91 executes the process a using the accepted sensor information. After the process a is executed, the execution result is sent to the request source application. In this case, since request A has been accepted from both application A and application B, the execution result is sent to both application A and application B as shown in S450 and S460.

### 5. Effects

The above-described present embodiment can provide the following effects.

(5a) In one aspect of the present disclosure, the first acceptance determination unit (S110) is configured to, in response to the first command being input from an application, determine whether the first command can be accepted using the resource information. The first output unit (S255) is configured to output the second command, which is based on the first command, to the operation control program (91 to 99) installed in the operation control device for controlling the control target when the first acceptance determination unit determines that the first command can be accepted.

When the first acceptance determination unit determines that the command cannot be accepted, the second acceptance determination unit (S150) is configured to determine whether the first command can be accepted after completing another processing within a set predetermined duration. When the second acceptance determination unit determines that the first command can be accepted within a predetermined duration, the second output unit (S410) waits until the first command can be accepted and outputs the second command to the operation control program when the first command can be accepted.

According to the above configuration, when acceptance of multiple requests output from multiple applications to access the vehicle functions are not allowed, the system is able to wait until the request become acceptable within a predetermined duration. Therefore, a control can be performed to prevent a shortage of vehicle resource within a tolerable range of system.

(5b) According to one aspect of the present disclosure, the system further includes a determination transmission unit (S260, S360) configured to transmit the determination results by the first acceptance determination unit and the second acceptance determination unit, to the application. The determination transmission unit (S260, S360) is configured to transmit, to the application, information indicating the duration until the first command becomes acceptable when the second acceptance determination unit determines that the first command becomes acceptable.

With this configuration, the application can be made aware of the remaining duration until the first command can be accepted.

(5c) According to one aspect of the present disclosure, the first acceptance determination unit and the second acceptance determination unit are configured to determine whether the first command can be accepted based on whether an operation of the operation control device corresponding to the first command conflicts with an operation corresponding to another process, in addition to the determination based on the resource information.

With this configuration, it is possible to determine whether the first command can be accepted with consideration of a conflict with another process.

(5d) According to one aspect of the present disclosure, the system further includes a third acceptance determination unit (S130). The third acceptance determination unit (S130) is configured to determine whether the same type of first command has been accepted from the second application while the second output unit is waiting until acceptance of the first command become possible. The second application is an application different from the first application, which has sent the first command.

The second output unit is configured to output a single second command based on the first command from the first application and the first command from the second application when the third acceptance determination unit determines that the same type of first command has been accepted.

According to this configuration, multiple first commands of the same type can be processed in integrated manner and output a single second command, thereby preventing output of duplicated second commands.

(5e) According to one aspect of the present disclosure, the system further includes a state prediction unit 852 configured to predict a future resource by calculation. The first acceptance determination unit is configured to use, as resource information, the current resource stored in the memory and the future resource predicted by the state prediction unit 852.

With this configuration, it is possible to determine whether the first command can be accepted using current resource and future resource.

(5f) According to one aspect of the present disclosure, the resource information includes characteristic information that differs depending on a vehicle type or individual vehicle.

With this configuration, it is possible to determine whether the first command can be accepted using the vehicle type. It is also possible to determine whether the first command can be accepted for individual vehicle.

### 6. Other Embodiments

While the present disclosure has been described with reference to embodiments thereof, it is to be understood that the disclosure is not limited to the described embodiments and configurations. The present disclosure is intended to cover various modification and equivalent arrangements. In addition, while the various combinations and configurations, other combinations and configurations, including more, less or only a single element, are also within the spirit and scope of the present disclosure.

(6a) In the above embodiment, the vehicle service unit 7 converts the first command into the second command. Alternatively, the state management unit 8 may convert the first command into the second command.

(6b) In the above embodiment, the predicted waiting time is generated each time a request is accepted. Alternatively, the predicted waiting time may be prepared in advance by periodically generating the predicted waiting time, and this prepared predicted waiting time may be used to determine whether processing can be executed.

(6c) In the above embodiment, the first ECU 10, the second ECU 15, and the center 35 each is provided with the service providing unit 6. The first ECU 10 is provided with the vehicle service unit 7. The first ECU 10, the third ECU 20, the fourth ECU 25, and the fifth ECU 30 each is provided with the state management unit 8. The fifth ECU 30 to the thirteenth ECU 48 each is provided with the equipment management unit 9. The number of ECUs belonging to the ECU group 100 and the way in which the functions of service providing unit 6, vehicle service unit 7, state management unit 8 and equipment management unit 9 are allocated to each ECU are not limited to the example described in the embodiment, that is, may be properly arranged in a different way.

(6d) Multiple functions of one element in the above embodiment may be implemented by multiple components, or a function of one component may be implemented by multiple components. Multiple functions of multiple elements may be implemented by one component, or a single function implemented by multiple components may be implemented by one component. In the above embodiment, a part of the configuration may be properly omitted. At least a part of the configuration of the above embodiment may be added to or substituted for the configuration of other embodiments.

(6e) In addition to the vehicle control device described above, the present disclosure can be implemented in various forms, such as a program for causing a computer to function as a vehicle control device, a non-transitory tangible storage medium such as a semiconductor memory in which this program is stored, and a vehicle control method.

What is claimed is:

1. A vehicle control system mounted on a vehicle, the vehicle control system comprising:
at least one vehicle control device; and
an operation control device,
wherein
the at least one vehicle control device includes at least one processor with a memory storing computer program code, and the at least one processor with the memory is configured to:
in response to a first command being input from an application of the at least one vehicle control device, determine whether the first command can be accepted based on resource information, the resource information being related to a processing capacity of resource to be used by the first command;
output, in response to determining that the first command can be accepted, a second command, which is generated based on the first command, to an operation control program that is installed in the operation control device for controlling a control target;
in response to determining that the first command cannot be accepted, determine whether the first command can be accepted within a predetermined upper limit processing duration based on the resource information; and
wait until the first command can be accepted and then output the second command to the operation control program in response to determining that the first command can be accepted within the predetermined upper limit processing duration.

2. The vehicle control system according to claim 1, wherein
the at least one processor with the memory is further configured to transmit, to the application, (i) determination result indicating whether the first command can be accepted and (ii) information indicating a standby duration until the first command can be accepted, in response to determining that the first command can be accepted.

3. The vehicle control system according to claim 1, wherein
the at least one processor with the memory is further configured to determine, in addition to a determination based on the resource information, whether the first command can be accepted depending on whether an operation of the operation control device corresponding to the first command conflicts with another operation corresponding to another processing.

4. The vehicle control system according to claim 1, wherein
the at least one processor with the memory is further configured to determine whether same type of the first command is accepted from a second application in a waiting state of the first command,
the application that has transmitted the first command is defined as a first application, and the second application is different from the first application that has transmitted the first command, and
the at least one processor with the memory is further configured to output, in response to determining that the same type of the first command being accepted from the second application, a single second command to the operation control program based on the first command from the first application and the first command from the second application.

5. The vehicle control system according to claim 1, wherein
the at least one processor with the memory is further configured to:
predict a future resource usage state by calculation; and
use, as the resource information, current resource information stored in a storage and future resource information, which includes the predicted future resource usage state.

6. The vehicle control system according to claim 1, wherein
the resource information includes characteristic information, and
the characteristic information differs depending on a vehicle type or individual vehicle.

7. A vehicle control method executed by at least one processor of a vehicle control device mounted on a vehicle, the vehicle control method comprising:
in response to a first command being input from an application of the vehicle control device, determining whether the first command can be accepted based on resource information, the resource information being related to a processing capacity of resource to be used by the first command;
outputting, in response to determining that the first command can be accepted, a second command, which is generated based on the first command, to an operation control program that is installed in an operation control device of the vehicle for controlling a control target;
in response to determining that the first command cannot be accepted, further determining whether the first command can be accepted within a predetermined upper limit processing duration based on the resource information; and
waiting until the first command can be accepted and then outputting the second command to the operation control program in response to determining that the first command can be accepted within the predetermined upper limit processing duration.

8. A non-transitory computer readable storage medium storing a program comprising instructions, when executed by at least one processor of a vehicle control device mounted on a vehicle, causing the at least one processor to:
in response to a first command being input from an application of the vehicle control device, determine whether the first command can be accepted based on resource information, the resource information being related to a processing capacity of resource to be used by the first command;
output, in response to determining that the first command can be accepted, a second command, which is generated based on the first command, to an operation control program that is installed in an operation control device of the vehicle for controlling a control target;
in response to determining that the first command cannot be accepted, further determine whether the first command can be accepted within a predetermined upper limit processing duration based on the resource information; and
wait until the first command can be accepted and then output the second command to the operation control program in response to determining that the first command can be accepted within the predetermined upper limit processing duration.
